(19) United States
(12) Patent Application Publication
(10) Pub. No.: US 2008/0114145 A1
(43) Pub. Date: May 15, 2008

(54) Self catalyzing polyurethanes

(76) Inventors: Richard Czarnecki, Wayne, NJ (US); Ralph Arcurio, Bridgewater, NJ (US); William Wilson, Hawthorne, NJ (US)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(21) Appl. No.: 11/595,216

(22) Filed: Nov. 9, 2006

(51) Int. Cl. C08G 71/04

(52) U.S. Cl. 528/67

(57) ABSTRACT

A method of preparing a polyurethane resin is disclosed which consists of reacting in the absence of an independent catalyst at least one diisocyanate compound with at least two diisocyanate reactive compounds such that at least one of the diisocyanate reactive compounds contains at least one isocyanate reactive group and a carboxylic acid functional group.

### FIELD OF THE INVENTION

The invention relates to a method of preparing a solvent based polyurethane resin by reacting in the absence of an independent catalyst a diisocyanate compound with a compound containing a carboxylic acid functional diisocyanate reactive group.

### BACKGROUND OF THE INVENTION

In the production of polyurethane resins, the reaction between a diisocyanate and a polyol is usually slow and a catalyst is used to accelerate the reaction rate. However, conventional catalysts are normally not removed from the final polymer and can present sensory or health hazards when used in sensitive end applications. It is desirable to identify an alternate route to minimize the reaction cycle time whilst avoiding the potential end use problems of conventional catalysts.

Typical catalysts used to accelerate the reaction of isocyanates and polyols include compounds of tin (dibutyltin dilaurate, dibutyltin oxide), tertiary amines, etc. These catalysts are typically not removed from the final product, and remain present in the polymer as a free substance. As such, they are available to migrate or leach out of applied coatings, and can present health or odor hazards in certain end use applications (e.g., food packaging).

In the synthesis of water dispersible polyurethanes and polyurethane-ureas, the use of isocyanate-reactive carboxylic functional compounds in the prepolymer provides pendant carboxylic acid functionality which can later be neutralized with alkali to enable the dispersion of the polymer into water. Common examples of these compounds include dimethylolpropionic acid and dimethylolbutanoic acid. In the synthesis of solvent based (non-water dispersible) polyurethanes and polyurethane-ureas (i.e., polymers dissolved in organic solvents), these compounds are typically not used as there is no need for such a stabilization mechanism in the absence of water.

### SUMMARY OF THE INVENTION

The present invention provides a method of preparing a polyurethane resin comprising reacting at least one diisocyanate compound with at least two diisocyanate reactive compounds wherein:

(a) at least one of said diisocyanate reactive compounds comprises at least one isocyanate reactive group and a carboxylic acid functional group; and

(b) said reaction is carried out in the absence of an independent catalyst.

Other objects and advantages of the present invention will become apparent from the following description and appended claims.

### DETAILED DESCRIPTION OF THE INVENTION

It has been surprisingly discovered that the use of isocyanate-reactive carboxylic acid functional compounds provides a self-catalyzing effect when incorporated into polyurethane and polyurethane-urea polymers. The catalytic effect is seen at both low (for example such as 0.05 equivalents) and high levels of incorporation into the polymer. The use of these compounds has been shown to significantly reduce reaction cycle time (vs. identical reactions without the use of such compounds).

Thus, the present invention is related to a solvent based polyurethane resin which is obtainable by reacting a mixture of aliphatic diisocyanate(s) and/or aromatic diisocyanate(s) with a group of isocyanate-reactive compounds, including at least one isocyanate-reactive compound containing at least one carboxylic acid functional group.

The term “aliphatic diisocyanate” is to be understood as to comprise straight-chain aliphatic, branched aliphatic as well as cycloaliphatic diisocyanates. Preferably, the diisocyanate comprises 1 to 10 carbon atoms. Examples of preferred diisocyanates are 1,4-diisocyanatobutane, 1,6-diisocyanatohexane, 1,5-diisocyanato-2,2-dimethylpentane, 4-trimethyl-1,6-diisocyanatohexane, 1,10-diisocyanatodecane, 1,3- and 1,4-diisocyanatocyclo-hexane, 1-isocyanato-5-isocyanatomethyl-3,3,5-trimethylcyclohexane (isophorone diisocyanate (IPDI)), 2,3-2,4- and 2,6-diisocyanato-1-methylcyclohexane, 4,4′- and 2,4′-diisocyanatodicyclohexylmethane, 1-isocyanato-3-(4)-isocyanatomethyl-1-methyl-cyclohexane, 4,4′- and 2,4′-diisocyanatodiphenylmethane, and mixtures thereof, or 2,2,4- or 2,4,4 trimethyldiisocyanatohexane (TMDI).

The term “aromatic diisocyanate” is to be understood as to compromise straight-chain aromatic, branched aromatic as well as cycloaromatic diisocyanates. Preferably, the diisocyanate comprises 1 to 10 carbon atoms. Examples of preferred diisocyanates are 1,1′-methylenebis[4-isocyanato-benzene (MDI), 1,6-diisocyanato-hexane (HDI), and 1,3-diisocyanatomethyl-benzene (TDI).

Isocyanate reactive compounds include and are not limited to mono, di, and multifunctional alcohols, as well as mono, di, and multifunctional amines, or compounds having both hydroxyl and amine functionality. The isocyanate reactive compounds also include and are not limited to polyether-polyols, polyester polyols and also low molecular weight polyols having a molecular weight between 50-20,000 g/mol.

Isocyanate reactive compounds may also include diol compounds. Thus, the diol components of the polyurethane resin of present invention are generally defined by the formula wherein R is a straight chain or branched hydrocarbon group. Examples of preferred diols include polyethyleneether glycols (PEG), polypropyleneether glycols (PPG), dimethylolpropionic acid (DMPA), polytetramethylene ether glycols (Poly-THF), 1,4-butanediol, 1,6-hexanediol, neopentyl glycol, or a mixture thereof. According to the present invention, the use of DMPA and Poly-THF is particularly preferred. Other diol components that may be utilized include polyester diols and polycaprolactone diols.

Optionally, a further isocyanate-reactive component with at least one diamine can be added. The diamine can be any aliphatic, cycloaliphatic, aromatic, or heterocyclic diamine having primary or secondary amino groups. Example are ethylenediamine, 1,2-diaminopropane, 1,3-diaminopropane, diaminobutane, hexamethylenediamine, 1,4-diaminocyclohexane, 3-aminomethyl-3,5,5-trimethylcyclohexylamine(isophorone diamine), m-xylylene diamine, hydrazine, or 1,3-bis(aminomethyl)cyclohexane.

Within the reaction mixture, there must be at least one carboxylic functional diisocyanate reactive component to act as a catalyst for the isocyanate/isocyanate-reactive compound (such as polyol) reaction which during the reaction is incorporated into the final polyurethane resin. These substances are incorporated into the backbone of the polymer, and as such are not free to leach out or migrate from the polymer in sensitive end use applications. The reaction mixture can either have an excess of isocyanate which can then be further reacted with a chain extension agent (either a polyol of multifunctional amine) or an excess of isocyanate-reactive compound such as polyol which would need no chain extension.

The amount of carboxylic functional diisocyanate reactive component can be as small as 0.05 (Example 2) equivalents or a much larger amount if functionality is required in the final polyurethane resin (Example 3).

The process of the present invention may be carried out in the presence of certain solvents. Furthermore, these solvents may be added to the polyurethane resin once the process of preparation of said resin is finished. Suitable solvents may include highly active solvents and combinations thereof depending on compatibility with the resin and end use requirements.

Such solvents may include and are not limited to ketones, aromatic hydrocarbons, aliphatic hydrocarbons, esters, and alcohols and the like, depending on the type of printing ink called for—either flexographic or gravure. It is preferred that the solvent be a combination of ester solvent and alcohol solvent.

Ester solvents include but are not limited to n-propyl acteate, ethyl acetate, butyl acetate, isopropyl acetate, propylene glycol monomethyl ether acetate and the like and combinations thereof. It is preferred that the ester solvent is ethyl acetate or propyl acetate.

Alcohol solvents include but are not limited to ethanol, propanol, ispropanol, glycol ethers, 1-ethoxy-2-propanol, propylene glycol n-propyl ether, dipropylene glycol, n-butyl ether, dipropylene glycol ethyl ether, diacetone alcohol, diethylene glycol monobutyl ether, propylene glycol methyl ether and the like and combinations thereof. It is preferred that the alcohol solvent is n-propanol or ethanol.

A benefit of this technology is that the catalytic effect is significantly more independent of reaction scale than with conventional external catalysts. In other words, the level of isocyanate-reactive carboxylic acid functional material in laboratory scale provides the same relative reaction rate when manufactured on a commercial scale. Many conventional external catalysts show a change in reaction speed, and need to be reduced as scale is increased.

A further benefit of this technology is that, when used at higher levels in the polymer, these compounds can provide significant pendant carboxylic acid functionality, which can be used as a site for subsequent reactions or as a means to improve adhesion on difficult substrates such as polyolefin films.

In summary, the benefits of the present invention as described hereinabove over the prior art are as follows:

1) elimination of the use of conventional catalysts;

2) elimination of end use hazards of metal based catalysts;
3) elimination of the end use restrictions on odor with amine-based catalysts;
4) elimination of leachable or extractable components of the final polymer;
5) incorporation of pendant carboxylic acid functionality present on isocyanate reactive compound for subsequent reactions or as an adhesion-promoting moiety; and
6) catalytic effect independent of reaction scale.

### EXAMPLE 1

### Comparative—Preparation of a Polyurethane Resin #1

### Step 1

A flask was charged with polytetrahydrofuran (PTHF Mw=2000; 393 g), polytetrahydrofuran (PTHF Mw=1000; 196 g), 1-isocyanato-5-isocyanatomethyl-3,3,5-trimethylcyclohexane (isophorone diisocyanate (IPDI; 131 g)), and propyl acetate (240 g). IPDI is a diisocyanate compound and PTHF is an isocyanate reactive compound that does not contain a carboxylic acid functional group. This mixture was then heated to 75° C. over 1 hour under nitrogen with constant agitation. The reaction was carried out over 20 hrs at 75° C. in the absence of an independent catalyst. The reaction was monitored by the process of % NCO determination. After the reaction was completed, the mixture was cooled and propyl acetate (240 g) is added.

### Step 2

After cooling the above mixture to 40° C., n-propanol (300 g) and ethylenediamine (11 g) were added over 15 minutes. The resulting mixture was then mixed for a further 1 hour.

### EXAMPLE 2

### Preparation of a Polyurethane Resin #2

### Step 1

A flask was charged with polytetrahydrofuran (PTHF; Mw=2000; 402 g), polytetrahydrofuran (PTHF Mw=1000; 181 g), dimethylolpropionic acid (DMPA; 3 g), isophorone diisocyanate (IPDI; 134 g), and propyl acetate (240 g). Both of PTHF and DMPA are isocyanate reactive compound with only DMPA containing a carboxylic acid functional group. This mixture was heated to 75° C. over 1 hour under nitrogen with constant agitation. The reaction was carried out over 5.5 hours at 75° C. The reaction mixture was monitored by the process of % NCO determination. After the reaction was completed, the mixture was then cooled and propyl acetate (240 g) was added.

### Step 2

After cooling the above mixture to 40° C., n-propanol (300 g) and ethylenediamine (12 g) were added over 15 minutes. The resulting mixture was then mixed for a further 1 hour.

The polyurethane resins derived from Example 1 and Example 2 were very similar in viscosity, percent solids, and molecular weight.

### EXAMPLE 3

### Preparation of a Polyurethane Resin #3

A flask was charged with polypropyleneether glycols (PPG Mw=2000; 354 g), polypropyleneether glycols (PPG Mw=1000; 171 g) dimethylolpropionic acid (DMPA; 23 g) and isophorone diisocyanate (IPDI; 173 g). Both of PPG and DMPA are isocyanate reactive compounds with only DMPA having a carboxylic acid functional group. This mixture was heated to 80° C. over 1 hour under nitrogen with constant agitation. The reaction was carried out over 6 hrs at 80° C. and monitored by the process of % NCO determination. After the reaction was completed, the mixture was then cooled and ethyl acetate (195 g) is added. Ethanol (656 g) and IPDA (12.3 g) (premixed) were added to the mixture over a 10 minute period and mixed for a further 1 hour.

### EXAMPLE 4

### Preparation of a Polyurethane Resin #4 in the Presence of Organotin Catalyst

### Step 1

A four necked flask is charged with PTHF 2000 (393 g), PTHF 1000 (196 g), IPDI (131 g) and dibutyltin dilaurate (prior art catalyst; 0.5 g of a 1% solution) in propyl acetate (240 g). This mixture is then heated to 75° C. over 1 hour under nitrogen with constant agitation. The reaction is carried out over 6 hrs at this temperature. The reaction mixture is monitored by % NCO determination. After the reaction is completed, the mixture is cooled and propyl acetate (240 g) is added.

### Step 2

After the flask has been cooled to 40° C. a mixture of n-propanol (300 g) and ethylenediamine (11 g) is added over 15 minutes. The reaction mixture is then allowed to mix for a further 1 hour. After the reaction was over, the dibutyltin dilaurate catalyst was nor removed from the polyurethane resin final product

Table 1 below compares the reaction time for the preparation of the polyurethane resins of Examples 1-4. The use of DMPA as an isocyanate reactive compound containing a carboxylic functional group significantly shortened the reaction time when compared with polyurethane resins prepared in the absence of a catalyst. In fact, the reaction time when DMPA was used is similar to the reaction time when dibutyltin dilaurate was used as an external catalyst in the preparation of polyurethane resins.

TABLE 1

| | Example 1 | Example 2 | Example 3 | Example 4 |
|---|---|---|---|---|
| Catalyst | NONE | 3 g DMPA | 23 g DMPA | 0.5 g of a 1% |
| used | | | | solution of |
| | | | | dibutyltin |
| | | | | dilaurate in |
| | | | | propyl acetate |
| Prepolymer | 20 | 5.5 | 6.0 | 6.0 |
| reaction | | | | |
| time, | | | | |
| hours | | | | |

The invention has been described in terms of preferred embodiments thereof, but is more broadly applicable as will be understood by those skilled in the art. The scope of the invention is only limited by the following claims.

What is claimed is:

1. A method of preparing a polyurethane resin comprising reacting at least one diisocyanate compound with at least two diisocyanate reactive compounds wherein:
(a) at least one of said diisocyanate reactive compounds comprises at least one isocyanate reactive group and a carboxylic acid functional group; and
(b) said reaction is carried out in the absence of an independent catalyst.

2. The method of claim 1, wherein said diisocyanate compound is an aliphatic diisocyanate compound.

3. The method of claim 2, wherein said aliphatic diisocyanate is selected from the group consisting of: 1,4-diisocyanatobutane, 1,6-diisocyanatohexane, 1,5-diisocyanato-2,2-dimethylpentane, 4-trimethyl-1,6-diisocyanatohexane, 1,10-diisocyanatodecane, 1,3- and 1,4-diisocyanatocyclo-hexane, 1-isocyanato-5-isocyanatomethyl-3,3,5-trimethylcyclohexane, 2,3-diisocyanato-1-methylcyclohexane, 2,4-diisocyanato-1-methylcyclohexane, 2,6-diisocyanato-1-methylcyclohexane, 4,4′-diisocyanatodicyclohexylmethane, 2,4′-diisocyanatodicyclohexylmethane, 1-isocyanato-3-(4)-isocyanatomethyl-1-methyl-cyclohexane, 4,4′-diisocyanatodiphenylmethane, 2,4′-diisocyanatodiphenylmethane, 2,2,4-trimethyldiisocyanatohexane and 2,4,4-trimethyldiisocyanatohexane.

4. The method of claim 1, wherein said diisocyanate compound is an aromatic diisocyanate compound.

5. The method of claim 4, wherein said aromatic diisocyanate 1,1′-methylenebis[4-isocyanato-benzene (MDI), 1,6-diisocyanato-hexane (HDI), and 1,3-diisocyanatomethyl-benzene (TDI).

6. The method of claim 1, wherein said isocyanate reactive compound is selected from the group consisting of monofunctional alcohol, difunctional alcohol, multifunctional alcohol, monofunctional amine, difunctional amine and multifunctional amine.

7. The method of claim 1, wherein said isocyanate reactive compound is selected from the group consisting of polyether-polyols, polycaprolactone polyols and polyester polyols.

8. The method of claim 1, wherein said isocyanate reactive compound is a polyol having a molecular weight between about 50 to 20,000 g/mol.

9. The method of claim 1, wherein said isocyanate reactive compound is a diol selected from the group consisting of: polyethyleneether glycols (PEG), polypropyleneether glycols (PPG), dimethylolpropionic acid (DMPA), polycaprolactone glycols, polytetramethylene ether glycols (Poly-THF), 1,4-butanediol, 1,6-hexanediol, neopentyl glycol, and a mixture thereof.

10. The method of claim 1, wherein said isocyanate reactive compound comprises at least two hydroxyl functional groups and at least one carboxylic acid functional group.

11. The method of claim 10, wherein said isocyanate reactive compound is dimethylolpropionic acid (DMPA).

12. The method of claim 1, wherein the product of said reaction is further reacted with a diamine compound.

13. The method of claim 1, wherein said diamine compound is ethylenediamine.

14. A polyurethane resin prepared according to the method of claim 1.
